(19) United States
(12) Patent Application Publication
(10) Pub. No.: US 2015/0231726 A1
(43) Pub. Date: Aug. 20, 2015

(54) METHOD FOR PRODUCING ARC-WELDED Zn-Al-Mg ALLOY COATED STEEL PLATE STRUCTURAL MEMBER

(71) Applicant: NISSHIN STEEL CO., LTD., Tokyo (JP)

(72) Inventors: Kazuaki Hosomi, Osaka (JP); Tomokazu Nobutoki, Osaka (JP); Hiroshi Asada, Osaka (JP)

(73) Assignee: NISSHIN STEEL CO., LTD., Tokyo (JP)

(21) Appl. No.: 14/183,804

(22) Filed: Feb. 19, 2014

(51) Int. Cl. B23K 9/16; B23K 9/23

(52) U.S. Cl. CPC B23K 9/164; B23K 9/23

(57) ABSTRACT

A method for producing an arc-welded Zn—Al—Mg alloy coated steel plate structural member excellent in liquid metal embrittlement cracking resistance is provided. The method contains a step of joining steel members by gas-shielded arc-welding to produce a welded structural member, at least one of the steel members to be used is a hot dip Zn—Al—Mg alloy coated steel plate member, and the shield gas contains an Ar gas, a He gas or an Ar—He mixed gas as a base gas with a CO₂ concentration controlled in a range of from 0 to 7% by volume.

### TECHNICAL FIELD

The present invention relates to a method for producing an arc-welded structural member constituted by a hot dip Zn—Al—Mg alloy coated steel plate member as one or both members to be welded, and the arc-welded structural member is excellent in liquid metal embrittlement cracking resistance.

### BACKGROUND ART

A hot dip zinc alloy coated steel plate is being widely used in various fields including a construction and an automotive body due to the good corrosion resistance thereof. In the hot dip zinc alloy coated steel plate, a hot dip Zn—Al—Mg alloy coated steel plate maintains the excellent corrosion resistance thereof for a prolonged period of time, and is in increasing demand as an alternate material for an ordinary hot dip galvanized steel plate.

As described in Japanese Patent Nos. 3,149,129 and 3,179,401, the coating layer of the hot dip Zn—Al—Mg alloy coated steel plate has a metal structure that contains a Zn/Al/Zn₂Mg ternary eutectic matrix having dispersed therein a primary Al phase, or a primary Al phase and a Zn phase, and the corrosion resistance is enhanced with Al and Mg. Since a dense and stable corrosion product especially containing Mg is uniformly formed on the surface of the coating layer, the corrosion resistance of the coating layer is drastically enhanced as compared to a hot dip galvanized steel plate.

In the fabrication of a construction or an automotive body with a hot dip Zn—Al—Mg alloy coated steel plate, a gas-shielded arc-welding method is often employed. The hot dip Zn—Al—Mg alloy coated steel plate has a problem that, on arc-welding thereof, liquid metal embrittlement cracking is liable to occur in the molten metal as compared to a galvanized steel plate. It has been noted that the problem occurs due to the decrease of the liquidus temperature of the coating layer caused by Mg contained (see Japanese Patent Nos. 4,475,787 and 3,715,220).

On arc-welding a metal coated steel plate, the metal of the coating layer is melted on the base steel around the portion where the arc passes. The coating layer of the Zn—Al—Mg alloy coated steel plate has a liquidus temperature that is lower than the melting point of Zn (approximately 420° C.) and maintains the molten state for a relatively long period of time. In an alloy of Zn-6% by mass Al-3% by mass Mg, for example, the solidification temperature is approximately 335° C. In the molten metal derived from the Zn—Al—Mg alloy coating layer molten on the surface of the base steel, the Al concentration is decreased with the consumption of the Al component through the reaction in the initial state with Fe which is the base steel to form an Fe—Al alloy layer, and the molten metal thus has a composition that is close to a Zn—Mg binary system, but an alloy of Zn-3% by mass Mg still has a solidification temperature of 360° C., which is lower than the melting point of Zn, 420° C. Accordingly, the Zn—Al—Mg alloy coated steel plate has a prolonged period of time where the molten metal of the coating layer molten on arc-welding remains on the surface of the base steel while maintaining the liquid phase state.

On exposing the surface of the base steel, which is suffering a tensile stress on cooling immediately after arc-welding, to the molten coating metal, the molten metal penetrates into the crystalline grain boundaries of the base steel to become a factor causing liquid metal embrittlement cracking. The liquid metal embrittlement cracking thus occurring acts as a starting point of corrosion and thus deteriorates the corrosion resistance. The liquid metal embrittlement cracking may also cause problems in deterioration of the strength and the fatigue characteristics.

As a measure for suppressing the liquid metal embrittlement cracking of the hot dip Zn—Al—Mg alloy coated steel plate on arc-welding, there has been a proposal that the coating layer is removed by grinding before arc-welding. Japanese Patent No. 3,715,220 discloses a method of providing resistance to liquid metal embrittlement cracking by using, as a base steel, a steel plate having ferrite crystalline grain boundaries having been strengthened by the addition of boron. JP-A-2005-230912 discloses a method of suppressing liquid metal embrittlement cracking in such a manner that Zn, Al and Mg are oxidized on arc-welding by filling a flux containing TiO₂ and FeO in the welding wire.

### Problems to be Solved by the Invention

The method of removing the coating layer by grinding and the method of using the special welding wire involve much increase in cost. The method of using the boron-added steel as the base steel material narrows the degree of freedom in selection of the species of steel. Furthermore, even though these methods are employed, there are cases where the liquid metal embrittlement cracking is not sufficiently prevented depending on the shape of the member and the welding condition, and thus these methods may still not be a fundamental measure for preventing the liquid metal embrittlement cracking of an arc-welded structure of a hot dip Zn—Al—Mg alloy coated steel plate.

In recent years, a high tensile strength steel plate having a tensile strength of 590 MPa or more is being used for reducing the weight of automobiles. A hot dip Zn—Al—Mg alloy coated steel plate using the high tensile strength steel plate suffers an increased tensile stress in the heat affected zone and thus is liable to suffer liquid metal embrittlement cracking, which may restrict the shapes of members and the purposes to be applied.

In view of the circumstances, an object of the invention is to provide excellent liquid metal embrittlement cracking resistance to an arc-welded structural member using a Zn—Al—Mg alloy coated steel plate member without restriction of the species of steel for the base steel and without much increase in cost.

### Means for Solving the Problems

According to the investigations made by the inventors, it has been confirmed that such a phenomenon occurs that the coated layer once disappears through evaporation in the vicinity of the weld bead on gas-shielded arc-welding, but after the arc passes, the metal of the coated layer that is in a molten state at the position somewhat apart from the bead spreads by wetting to the portion where the coated layer has disappeared. It is considered that by preventing the spread by wetting until completion of the cooling while maintaining the state where the coated layer disappears through evaporation, the penetration of the coated layer component to the base steel in the vicinity of the weld bead may be avoided, and thus the liquid metal embrittlement cracking may be effectively prevented. As a result of the detailed investigations made by the inventors, it has been found that the spread by wetting in a Zn—Al—Mg alloy coated steel plate member may be remarkably suppressed by decreasing largely the concentration of CO₂, which is generally mixed in the shield gas in an amount of approximately 20% by volume, and thus the invention has been completed.

The invention relates to, as one aspect, a method for producing an arc-welded Zn—Al—Mg alloy coated steel plate structural member excellent in liquid metal embrittlement cracking resistance, the method containing a step of joining steel members by gas-shielded arc-welding to produce a welded structural member, at least one of the steel members to be jointed being a hot dip Zn—Al—Mg alloy coated steel plate member, and the shield gas containing an Ar gas, a He gas or an Ar—He mixed gas as a base gas with a CO₂ concentration controlled to a range of from 0 to 7% by volume.

The hot dip Zn—Al—Mg alloy coated steel plate member referred herein is a member formed of a hot dip Zn—Al—Mg alloy coated steel plate or a member obtained by forming the same as a raw material.

The hot dip Zn—Al—Mg alloy coated steel plate preferably has a coated layer that contains: from 1.0 to 22.0% by mass, and preferably from 4.0 to 22.0% by mass, of Al; from 0.05 to 10.0% by mass of Mg; from 0 to 0.10% by mass of Ti; from 0 to 0.05% by mass of B; from 0 to 2.0% by mass of Si; from 0 to 2.5% by mass of Fe; the balance of Zn; and unavoidable impurities. The coating weight thereof is preferably from 20 to 250 g/m² per one surface.

### Advantages of the Invention

According to the invention, excellent liquid metal embrittlement cracking resistance may be imparted to an arc-welded structure using a hot dip Zn—Al—Mg alloy coated steel plate, which is inherently liable to suffer liquid metal embrittlement cracking, without any particular increase in cost. There is no particular restriction in the kind of base steel, and thus there is no necessity of the use of a steel having a special element added for preventing liquid metal embrittlement cracking. The excellent liquid metal embrittlement cracking resistance may also be obtained with a high tensile strength steel plate. Further, the degree of freedom in the shapes of members is also large. Accordingly, the invention may contribute to the spread of an arc-welded hot dip Zn—Al—Mg alloy coated steel plate structural member in wide varieties of fields including an arc-welded structural member for an automobile using a high tensile strength steel plate whose demands are expected to be larger in the future.

### BRIEF DESCRIPTION OF THE DRAWINGS

FIG. 1 is a schematic cross sectional view showing a torch and a base steel in gas-shielded arc-welding.

FIG. 2 is a schematic cross sectional view showing a welded part of a lap joint.

FIG. 3 is a schematic cross sectional view showing a vicinity of a welded part of a hot dip Zn—Al—Mg alloy coated steel plate in arc-welding, in which the welded part is at a high temperature immediately after an arc passes.

FIG. 4 is a schematic cross sectional view showing a vicinity of a welded part of an ordinary hot dip Zn—Al—Mg alloy coated steel plate arc-welded structural member, in which the welded part is cooled from the state shown in FIG. 3.

FIG. 5 is a schematic cross sectional view showing a vicinity of a welded part of a hot dip Zn—Al—Mg alloy coated steel plate arc-welded structural member according to the invention, in which the welded part is cooled from the state shown in FIG. 3.

FIG. 6 is a graph showing influence of a CO₂ concentration in a shield gas on a length of a portion of a Zn—Al—Mg alloy coated steel plate arc-welded structural member where a coated layer is evaporated.

FIG. 7 is a schematic perspective view showing a welding experiment method for investigating liquid metal embrittlement cracking resistance.

### EMBODIMENTS FOR CARRYING OUT THE INVENTION

FIG. 1 is a schematic cross sectional view showing a torch and a material in gas-shielded arc-welding. The welding torch 31 proceeds in the direction shown by the arrow while forming an arc 35 on a surface of a material 1. A shield gas 34 is blown from a circumference of an electrode 33 and a welding wire 32, which are positioned at the center of the welding torch 31, and protects the arc 35 and the surface of the material 1 exposed to a high temperature from the air. A part of the material 1 that has been molten through heat input from the arc 35 is quickly solidified after the welding torch 31 passes to form a weld bead 2 formed of a weld metal. The shield gas 34 is necessarily a nonoxidizing gas, and examples of the shield gas used include an Ar—CO₂ mixed gas containing an inert gas such as Ar as a base gas having CO₂ added in an amount of approximately 20% by volume. It is considered that CO₂ in the shield gas 34 is partially dissociated to CO and O₂ with the arc 35 in a plasma state, and the CO exhibits a reducing function, by which the surface of the material 1 is activated, and the weld bead and the vicinity thereof are prevented from being oxidized. It is also considered that CO₂ stabilizes the arc 35.

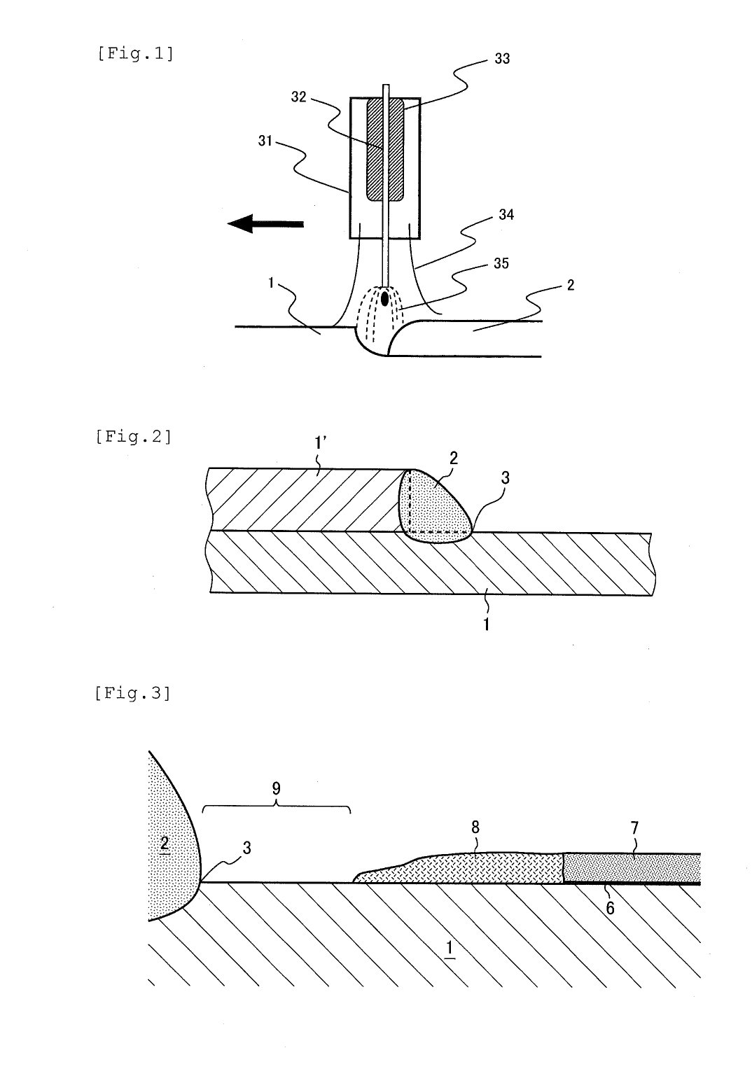

FIG. 2 is a schematic cross sectional view showing a welded part of a lap joint. This type of a welded joint by arc-welding is often used in a chassis of an automobile and the like. A material 1 and another material 1′, which are steel plate members, are disposed and lapped on each other, and the materials 1 and 1′ are jointed by forming a weld bead 2 on the surface of the material 1 and the end surface of the material 1′. The broken line in the figure shows the position of the surface of the material 1 and the position of the end surface of the material 1′ before welding. The intersecting point of the surface of the material and the weld bead is referred to as a toe of weld. In the figure, the toe of weld on the material 1 is shown by the numeral 3.

FIGS. 3 to 5 are enlarged schematic cross sectional views showing the portion corresponding to the vicinity of the toe of weld 3 shown in FIG. 2.

FIG. 3 is a schematic cross sectional view showing a vicinity of a welded part of a hot dip Zn—Al—Mg alloy coated steel plate in gas-shielded arc-welding, in which the welded part is at a high temperature immediately after an arc passes. The surface of the material 1 was covered with a uniform coated layer 7 through an Fe—Al alloy layer 6 before welding, but the metal of the coated layer disappears through evaporation in a region near the toe of weld 3 (i.e., a coated layer evaporated region 9) after the arc passes. In a region with a larger distance from the toe of weld 3 than the coated layer evaporated region 9, the original coated layer 7 is molten to form a Zn—Al—Mg molten metal 8 but does not reach the disappearance through evaporation. In a region with a further larger distance from the toe of weld 3, the original coated layer 7 remains without being molten. In FIG. 3, the thicknesses of the Zn—Al—Mg molten metal 8 and the coated layer 7 are shown with exaggeration.

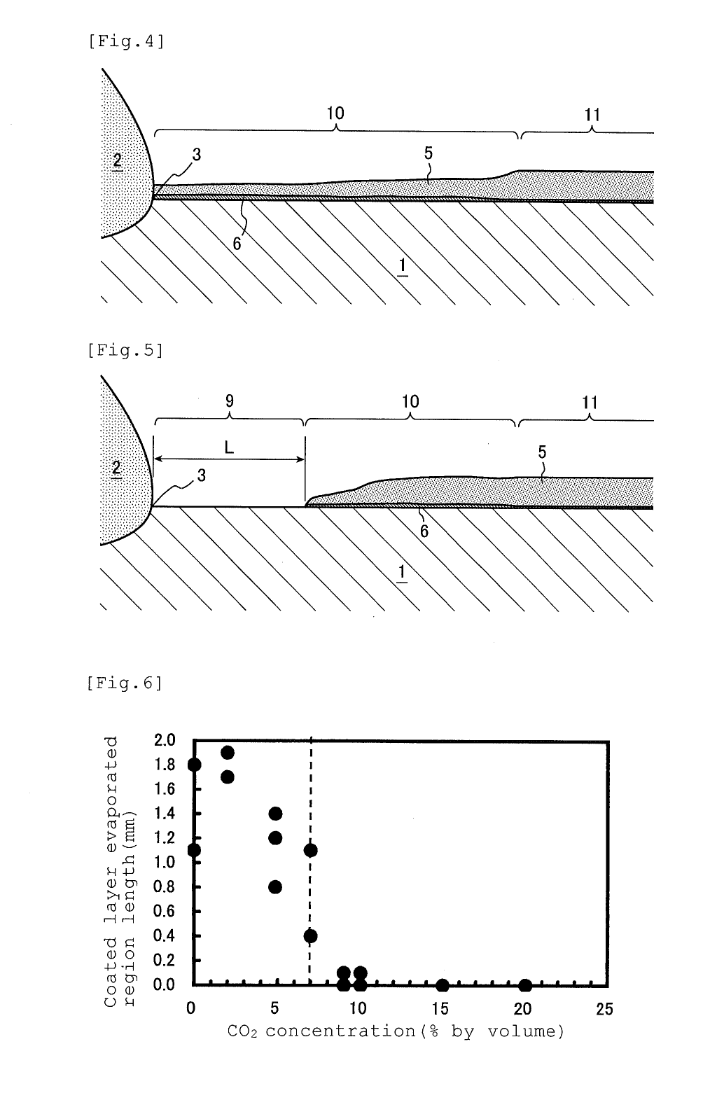

FIG. 4 is a schematic cross sectional view showing the vicinity of the welded part of an ordinary hot dip Zn—Al—Mg alloy coated steel plate arc-welded structural member, in which the welded part is cooled from the state shown in FIG. 3. In this case, the Zn—Al—Mg molten metal (denoted by the numeral 8 in FIG. 3) spreads by wetting over the coated layer evaporated region (denoted by the numeral 9 in FIG. 3) formed by temporal disappearance of the coated layer in welding, and the entire surface of the material 1 is covered up to the toe of weld 3 with a Zn—Al—Mg alloy layer 5. The portion of the Zn—Al—Mg alloy layer 5 that is formed through solidification of the Zn—Al—Mg molten metal (denoted by the numeral 8 in FIG. 3) is referred to as a molten metal solidified region 10, and the portion of the Zn—Al—Mg alloy layer 5 that is formed with the original coated layer 7 remaining is referred to as a non-molten coated layer region 11. In an ordinary Zn—Al—Mg alloy coated steel plate arc-welded structural member, the portion just next to the toe of weld 3 is the molten metal solidified region 10 as shown in the figure. In this case, the Zn—Al—Mg molten metal 8 has a low liquidus temperature as described above, and thus the portion of the surface of the material 1 to be the molten metal solidified region 10 after cooling is in contact with the Zn—Al—Mg molten metal for a relatively long period of time in the cooling process after welding. The portion of the r material 1 that is close to the toe of weld occurs a tensile stress on cooling after welding, and thus the component of the Zn—Al—Mg molten metal is liable to penetrate the crystalline grain boundaries. The component that thus penetrates the grain boundaries may be a factor causing liquid metal embrittlement cracking.

FIG. 5 is a schematic cross sectional view showing the vicinity of the welded part of a hot dip Zn—Al—Mg alloy coated steel plate arc-welded structural member according to the invention, in which the welded part is cooled from the state shown in FIG. 3. In the invention, the shield gas used is a gas having a largely decreased CO₂ concentration or a gas having no CO₂ added. Accordingly, it is considered that the surface of the material 1 in the coated layer evaporated region (denoted by the numeral 9 in FIG. 3) where the coated layer has disappeared on welding is oxidized due to the weak reducing function of the shield gas, and thus quickly covered with a thin oxidized film. It is thus expected that the oxidized film prevents wetting of the Zn—Al—Mg molten metal (denoted by the numeral 8 in FIG. 3), and thus the Zn—Al—Mg molten metal is prevented from spreading by wetting. As a result, the coated layer evaporated region 9 remains after cooling. Thus, the cooling process is completed without contact between the surface of the material 1 in the vicinity of the toe of weld 3 and the Zn—Al—Mg molten metal, and thereby the molten metal component is prevented from penetrating the material 1 in the region. Consequently, excellent liquid metal embrittlement cracking resistance may be provided irrespective of the species of steel of the material 1. Even in such a welding position that the height of the Zn—Al—Mg molten metal (denoted by the numeral 8 in FIG. 3) is above the toe of weld 3, the Zn—Al—Mg molten metal is effectively prevented from spreading by wetting, due to the aforementioned wetting preventing effect.

The distance between the end of the coated layer evaporated region 9 remaining after cooling and the toe of weld 3 is referred to as a coated layer evaporated region length, which is denoted by the symbol L in FIG. 5. The liquid metal embrittlement cracking, which is a problem occurring in a Zn—Al—Mg alloy coated steel plate arc-welded structural member, almost occurs in the close vicinity of the toe of weld 3. As a result of the various investigations, it has been found that the liquid metal embrittlement cracking resistance may be largely enhanced when the coated layer evaporated region length is preferably 0.3 mm or more, and more preferably 0.4 mm or more. In the case where the coated layer evaporated region length is too large, there may be a problem of deterioration of the corrosion resistance due to the absence of the coated layer, and according to the investigations by the inventors, it has been found that when the coated layer evaporated region length is 2.0 mm or less, a sufficient sacrificial protection may be obtained by the surrounding Zn—Al—Mg alloy coated layer, and thus there may be no problem in deterioration of the corrosion resistance in the region. The coated layer evaporated region length may be controlled in the range of from 0.3 to 2.0 mm by controlling the composition of the shield gas as described later.

### Gas-shielded Arc-Welding Condition

In the arc-welding according to the invention, it is important to control the CO₂ concentration of the shield gas in the range of from 0 to 7% by volume. As described above, CO₂ contained in the shield gas is partially dissociated to CO and O₂ through contact with the plasma arc, and the surface of the steel in the vicinity of the weld bead is activated by the reducing function of CO. In ordinary gas-shielded arc-welding, a shield gas containing CO₂ in an amount of approximately 20% by volume is generally used to exhibit the reducing function sufficiently and to increase the depth of penetration through stabilization of the arc. In the invention, however, the reducing function is suppressed or is completely not used, and thus the surface of the base steel in the vicinity of the welded part where the coated layer is disappeared through evaporation is prevented from being activated excessively, thereby preventing the Zn—Al—Mg molten metal present on the surrounding surface of the base steel from spreading by wetting to the toe of weld. As a result of the detailed investigations, the effect of preventing the spread by wetting may be obtained when the CO₂ concentration is 7% by volume or less, and thereby the coated layer evaporated region length may be controlled in the range of from 0.3 to 2.0 mm. It is more effective that the CO₂ concentration is less than 5.0% by volume. The base gas used in the shield gas may be an Ar gas, a He gas or an Ar—He mixed gas, as similar to an ordinary shield gas. The purity of the base gas may also be the same as an ordinary shield gas.

The other welding conditions may be controlled, for example, in ranges of a shield gas flow rate of from 10 to 30 L/min, a welding current of from 90 to 350 A, an arc voltage of from 10 to 35 V, and a welding speed of from 0.2 to 1.5 m/min. An ordinary welding equipment may be used in the invention.

An example of an experiment for investigating the relationship between the CO₂ concentration in an Ar gas and the coated layer evaporated region length will be shown below. A hot dip Zn—Al—Mg alloy coated steel plate shown in Table 1 was placed horizontally, and a weld bead was formed on the surface of the steel plate (bead-on-plate) with an arc generated from a welding torch moving horizontally. The welding conditions are shown in Table 1. The vertical cross section including the weld bead and the material in the vicinity thereof perpendicular to the bead direction was subjected to mirror polishing and etching with a Nital solution having a nitric acid concentration of 0.2% by volume, and then observed with a scanning electron microscope. The vicinity of the toe of weld was observed, and the coated layer evaporated region length denoted by the symbol L in FIG. 5 was measured.

TABLE 1

| | | |
|---|---|---|
| Hot dip | Composition of | Al: 6.1% by mass; Mg: 3.1% by mass; |
| Zn—Al—Mg | coated layer | Zn: balance |
| alloy coated | Base steel | low carbon Al killed steel |
| steel plate | Size | thickness: 3.2, width: 100, |
| | | length: 150 (mm) |
| | Coating weight | 90 g/m² per one surface |

| | |
|---|---|
| Welding wire | YGW12, diameter: 1.2 mm |
| Composition of shield gas | Ar, CO₂, Ar—CO₂ 2-80% by volume |
| Flow rate of shield gas | 20 L/min |
| Welding current | 150 A |
| Arc voltage | 19 V |
| Welding speed | 0.4 m/min |
| Bead length | 100 mm |

The results are shown in FIG. 6. It is understood from FIG. 6 that when the CO₂ concentration in the shield gas is 7% by volume or less, the phenomenon that the coated layer evaporated region remains on cooling is clearly observed, and a coated layer evaporated region length of 0.3 mm or more is ensured. Three specimens positioned near a CO₂ concentration of 5% by volume are examples with a CO₂ concentration of 4.8% by volume, and thus when the CO₂ concentration is less than 5.0% by volume, the coated layer evaporated region length may be 0.8 mm or more, thereby providing a considerably enhanced liquid metal embrittlement cracking resistance.

### Hot Dip Zn—Al—Mg Alloy Coated Steel Plate Member

In the invention, at least one of the members to be jointed by arc-welding is a hot dip Zn—Al—Mg alloy coated steel plate member.

The base material of the hot dip Zn—Al—Mg alloy coated steel plate member may be various species of steel depending on purposes. A high tensile strength steel plate may be used therefor. The thickness of the base steel may be from 1.0 to 6.0 mm.

Specific examples of the composition of the coated layer of the hot dip Zn—Al—Mg alloy coated steel plate include from 1.0 to 22.0% by mass, and preferably from 4.0 to 22.0% by mass of Al; from 0.05 to 10.0% by mass of Mg; from 0 to 0.10% by mass of Ti; from 0 to 0.05% by mass of B; from 0 to 2.0% by mass of Si; from 0 to 2.5% by mass of Fe; the balance of Zn; and unavoidable impurities. The composition of the coated layer substantially reflects the composition of the hot dip coating bath. The method for hot dip coating is not particularly limited, and in general, the use of an in-line annealing type hot dip coating equipment is advantageous in cost. The component elements of the coated layer will be described below. The percentage for the component element of the coated layer means the percentage by mass unless otherwise indicated.

Al is effective for enhancing the corrosion resistance of the coated steel plate, and suppresses the formation of a Mg oxide dross in the hot dip coating bath. For exhibiting the functions sufficiently, an Al content of 1.0% or more is preferably ensured, and an Al content of 4.0% or more is more preferably ensured. When the Al content is too large, on the other hand, a brittle Fe—Al alloy layer is liable to grow as an underlayer of the coated layer, and the excessive growth of the Fe—Al alloy layer may be a factor causing deterioration of the coating adhesion. As a result of the various investigations, the Al content is preferably 22.0% or less, and may be more preferably controlled to 15.0% or less, and further preferably 10.0% or less.

Mg has an effect of forming a homogeneous corrosion product on the surface of the coated layer and largely enhances the corrosion resistance of the coated steel plate. The Mg content is preferably 0.05% or more, and more preferably 1.0% or more. When the Mg content in the coating bath is too large, on the other hand, a Mg oxide dross is liable to be formed, which may be a factor causing deterioration of the quality of the coated layer. The Mg content is preferably in a range of 10.0% or less.

When the hot dip coating bath contains Ti and B, such an advantage is obtained that the degree of freedom in production conditions on hot dip coating. Accordingly, one or both of Ti and B may be added depending on necessity. The addition amounts thereof may be effectively 0.0005% or more for Ti and 0.0001% or more for B. When the contents of Ti and B in the coated layer are too large, they may be a factor of causing appearance failure of the surface of the coated layer due to precipitates formed thereby. In the case where these elements are added, the contents thereof are preferably 0.10% or less for Ti and 0.05% or less for B.

When the hot dip coating bath contains Si, such an advantage is obtained that the excessive growth of the Fe—Al alloy layer formed at the interface between the surface of the base steel and the coated layer may be suppressed, and thus the processability of the hot dip Zn—Al—Mg alloy coated steel plate may be improved. Accordingly, Si may be added depending on necessity. In this case, the Si content is preferably 0.005% or more. Too large Si content may be a factor increasing the dross amount in the hot dip coating bath, and therefore the Si content is preferably 2.0% or less.

The hot dip coating bath is liable to contain Fe since steel plates are dipped therein and passed therethrough. The Fe content in the Zn—Al—Mg alloy coating layer is preferably 2.5% or less.

When the coating weigh of the hot dip Zn—Al—Mg alloy coated steel plate member is too small, it is disadvantageous for maintaining the corrosion resistance and the sacrificial protection of the coated surface for a prolonged period of time. As a result of the various investigations, in the case where the coated layer evaporated region formed in the vicinity of the toe of weld is left according to the invention, it is effective that the coating weigh is preferably from 20 g/m² or more per one surface. When the coating weigh is too large, on the other hand, blow holes are liable to occur on welding to deteriorate the weld strength. Accordingly, the coating weigh is preferably 250 g/m² or less per one surface.

### Opposite Member for Welding

The opposite member to be jointed to the hot dip Zn—Al—Mg alloy coated steel plate member by arc-welding may be a Zn—Al—Mg alloy coated steel plate member similar to the above and may be other kinds of steel.

### Example

A cold-rolled steel strip having the composition shown in Table 2 below and having a thickness of 3.2 mm and a width of 1,000 mm was subjected to a hot dip coating line to produce hot dip Zn—Al—Mg alloy coated steel plates having various coated layer compositions. The coated steel plates were subjected to gas-shielded arc-welding according to the test method shown later, and the influence of the composition of the shield gas on the liquid metal embrittlement cracking property was investigated. The composition of the coating layer, the coating weigh and the composition of the shield gas are shown in Table 4. The shield gases according to the invention had a composition containing from 0 to 7% by volume of CO₂ and the balance of at least one of Ar and He.

TABLE 2

| | Chemical composition (% by mass) | | | | | | |
|---|---|---|---|---|---|---|---|
| Steel | C | Si | Mn | Al | Ti | Nb | Note |
| A | 0.22 | 0.006 | 0.8 | 0.04 | — | — | 490 MPa class high |
| | | | | | | | tensile strength steel |
| B | 0.11 | 0.10 | 1.8 | 0.04 | — | — | 590 MPa class high |
| | | | | | | | tensile strength steel |
| C | 0.11 | 0.4 | 2.0 | 0.4 | 0.04 | 0.02 | 980 MPa class high |
| | | | | | | | tensile strength steel |

### Test Method for Liquid Metal Embrittlement Cracking Property

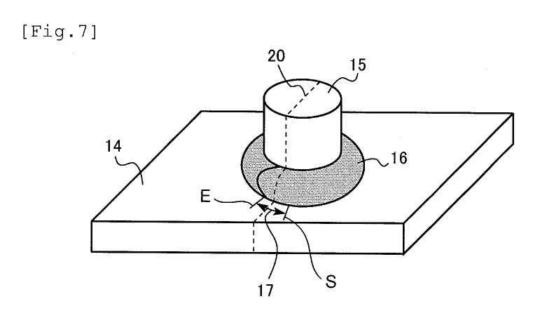

As shown in FIG. 7, a steel rod as a boss (protrusion) 15 having a diameter of 20 mm and a length of 25 mm was set up vertically on the center of a test specimen 14 (hot dip Zn—Al—Mg alloy coated steel plate member) having a dimension of 100 mm×75 mm, and the test specimen 14 and the boss 15 were welded by gas-shielded arc-welding under the welding conditions shown in Table 3. Specifically, the welding was performed from the welding starting point S in the clockwise direction, and after going round the boss 15, the welding was further performed through the welding starting point S with the weld beads overlapping, up to the welding end point E to form an overlapping portion 17 of the weld bead 16. The test specimen 14 was fixed to a flat plate on welding. The test experimentally replicates a situation where weld cracking is liable to occur.

TABLE 3

| | |
|---|---|
| Welding wire | YGW12, diameter: 1.2 mm |
| Composition of shield gas | Invention: |
| | base gas: Ar, He, Ar—He mixed gas |
| | CO₂: 0-7% by volume |
| | Comparison: |
| | CO₂, Ar—CO₂ 9-20% by volume |
| Flow rate of shield gas | 20 L/min |
| Welding current | 150 A |
| Arc voltage | 19 V |
| Welding speed | 0.4 m/min |

After welding, a cross sectional 20 passing through the center axis of the boss 15 and the overlapping portion 17 of the weld bead was observed with a scanning electron microscope for the portion of the test specimen 14 in the vicinity of the overlapping portion 17 of the weld bead, thereby measuring the depth of the deepest crack (i.e., the maximum crack depth) observed in the test specimen 14. The crack was determined as liquid metal embrittlement cracking. The results are shown in Table 4.

TABLE 4

| | | Composition of Zn-Al-Mg alloy coated | | | | | | Coating weight | Composition of | | | | |
|---|---|---|---|---|---|---|---|---|---|---|---|---|---|
| | | layer (balance: Zn) | | | | | | (per one | shield gas | | | Maximum | |
| | | (% by mass) | | | | | | surface) | (% by volume) | | | crack depth | |
| No. | Steel | Al | Mg | Si | Ti | B | Fe | (g/m²) | Ar | He | CO₂ | (mm) | Note |
| 1 | A | 4.1 | 0.05 | — | — | — | — | 44 | 100.0 | 0.0 | 0.0 | 0 | Example |
| 2 | B | 6.2 | 2.9 | 0.5 | 0.05 | 0.02 | — | 92 | 50.0 | 50.0 | 0.0 | 0 | |
| 3 | C | 21.2 | 9.6 | 0.5 | 0.03 | 0.01 | 0.7 | 195 | 0.0 | 100.0 | 0.0 | 0 | |
| 4 | A | 4.1 | 0.05 | 0.3 | — | — | 0.5 | 44 | 98.0 | 0.0 | 2.0 | 0 | |
| 5 | B | 6.2 | 2.9 | 1.5 | — | — | 0.4 | 92 | 49.0 | 49.0 | 2.0 | 0 | |
| 6 | C | 21.2 | 9.6 | — | — | — | 0.5 | 195 | 0.0 | 98.0 | 2.0 | 0 | |
| 7 | A | 4.5 | 1.1 | 0.5 | — | — | — | 35 | 97.0 | 0.0 | 3.0 | 0 | |
| 8 | A | 6.1 | 3.1 | — | — | — | — | 88 | 77.0 | 20.0 | 3.0 | 0 | |
| 9 | B | 14.5 | 7.7 | — | — | — | 1.2 | 129 | 50.0 | 47.0 | 3.0 | 0 | |
| 10 | C | 17.8 | 8.1 | 0.3 | — | — | 1.6 | 165 | 0.0 | 97.0 | 3.0 | 0 | |
| 11 | C | 21.6 | 9.2 | 0.5 | — | — | — | 240 | 95.2 | 0.0 | 4.8 | 0 | |
| 12 | A | 4.5 | 1.1 | 0.5 | — | 0.04 | 0.6 | 35 | 75.2 | 20.0 | 4.8 | 0 | |
| 13 | A | 6.1 | 3.1 | 0.5 | 0.04 | 0.01 | — | 88 | 50.2 | 45.0 | 4.8 | 0 | |
| 14 | A | 10.9 | 2.9 | 0.2 | — | — | — | 91 | 95.2 | 0.0 | 4.8 | 0 | |
| 15 | B | 14.5 | 7.7 | 1.3 | — | — | 2.0 | 129 | 20.1 | 75.0 | 4.9 | 0 | |
| 16 | C | 17.8 | 8.1 | 1.9 | — | — | 2.3 | 165 | 0.0 | 95.2 | 4.8 | 0 | |
| 17 | C | 21.6 | 9.2 | 0.5 | — | — | 0.3 | 240 | 74.0 | 20.0 | 6.0 | 0 | |
| 18 | A | 4.4 | 0.07 | 0.7 | — | — | 0.5 | 41 | 93.0 | 0.0 | 7.0 | 0 | |
| 19 | B | 6.0 | 3.1 | 0.7 | 0.09 | 0.02 | — | 62 | 60.0 | 33.0 | 7.0 | 0 | |
| 20 | C | 15.6 | 5.0 | — | 0.05 | — | — | 115 | 20.0 | 73.0 | 7.0 | 0 | |
| 21 | C | 21.3 | 9.1 | — | — | — | — | 189 | 0.0 | 93.0 | 7.0 | 0 | |
| 31 | A | 4.2 | 1.6 | — | — | — | — | 34 | 91.0 | 0.0 | 9.0 | 0.5 | Comparative |
| 32 | B | 6.2 | 2.9 | — | — | — | 0.5 | 92 | 0.0 | 91.0 | 9.0 | 2.0 | Example |
| 33 | C | 20.5 | 9.5 | — | — | — | 0.4 | 180 | 45.0 | 45.0 | 10.0 | 3.2 | |
| 34 | A | 4.5 | 1.1 | — | — | — | 0.5 | 45 | 85.0 | 0.0 | 15.0 | 0.9 | |
| 35 | B | 11.2 | 2.9 | 1.3 | — | — | — | 62 | 45.0 | 40.0 | 15.0 | 1.5 | |
| 36 | C | 21.0 | 9.9 | — | 0.05 | 0.01 | 0.5 | 240 | 0.0 | 85.0 | 15.0 | 3.2 | |
| 37 | A | 4.4 | 1.2 | 0.5 | — | — | — | 60 | 80.0 | 0.0 | 20.0 | 0.7 | |
| 38 | A | 6.3 | 3.0 | 0.5 | 0.05 | 0.01 | — | 89 | 50.0 | 30.0 | 20.0 | 2.0 | |
| 39 | C | 17.5 | 7.1 | — | — | — | — | 160 | 0.0 | 80.0 | 20.0 | 3.2 | |
| 40 | A | 5.5 | 0.9 | — | — | — | — | 76 | 0.0 | 0.0 | 100.0 | 1.3 | |
| 41 | B | 10.1 | 6.9 | 1.9 | — | — | — | 155 | 0.0 | 0.0 | 100.0 | 3.2 | |
| 42 | C | 21.6 | 8.3 | — | — | — | — | 234 | 0.0 | 0.0 | 100.0 | 3.2 | |
| 43 | A | 1.0 | 0.05 | — | — | — | — | 39 | 100.0 | 0.0 | 0.0 | 0 | Example |
| 44 | A | 1.1 | 0.07 | 0.2 | — | — | 0.2 | 54 | 75.0 | 25.0 | 0.0 | 0 | |
| 45 | B | 1.0 | 1.1 | — | — | — | — | 55 | 94.0 | 0.0 | 6.0 | 0 | |
| 46 | B | 1.1 | 0.9 | 0.1 | — | 0.05 | 0.4 | 66 | 55.0 | 40.0 | 5.0 | 0 | |
| 47 | C | 1.2 | 1.0 | 0.1 | 0.03 | 0.01 | 0.02 | 89 | 90.0 | 6.0 | 4.0 | 0 | |
| 48 | A | 1.1 | 1.2 | — | — | — | — | 44 | 0.0 | 80.0 | 20.0 | 0.9 | Comparative |
| 49 | B | 1.0 | 1.2 | 0.01 | 0.01 | — | — | 56 | 35.0 | 50.0 | 15.0 | 2.6 | Example |
| 50 | C | 1.2 | 1.6 | 0.2 | — | 0.02 | — | 98 | 40.0 | 51.0 | 9.0 | 3.0 | |

As shown in Table 4, liquid metal embrittlement cracking was observed in the specimens of Comparative Examples where the CO₂ concentration in the shield gas was 9% by volume or more. In all these specimens, the coated layer evaporated region length L (see FIG. 3) in the test specimen 14 was less than 0.3 mm, and the deepest liquid metal embrittlement cracking was formed at the position within a distance of 0.3 mm or less from the toe of weld in substantially all the specimens. In the specimens of Examples of the invention with a CO₂ concentration of less than 7% by volume, on the other hand, no liquid metal embrittlement cracking was observed. The coated layer evaporated region lengths L in the specimens of the invention were all 0.3 mm or more, and the coated layer evaporated region lengths L in the specimens with a CO₂ concentration of less than 5% by volume were 0.6 mm or more.

1. A method for producing an arc-welded Zn—Al—Mg alloy coated steel plate structural member excellent in liquid metal embrittlement cracking resistance, the method comprising a step of joining steel members by gas-shielded arc-welding to produce a welded structural member, at least one of the steel members to be used being a hot dip Zn—Al—Mg alloy coated steel plate member, and the shield gas containing an Ar gas, a He gas or an Ar—He mixed gas as a base gas with a CO₂ concentration controlled in a range of from 0 to 7% by volume.

2. The method for producing an arc-welded Zn—Al—Mg alloy coated plated steel plate structural member excellent in liquid metal embrittlement cracking resistance according to claim 1, wherein the hot dip Zn—Al—Mg alloy coated steel plate has a coated that contains: from 1.0 to 22.0% by mass of Al; from 0.05 to 10.0% by mass of Mg; from 0 to 0.10% by mass of Ti; from 0 to 0.05% by mass of B; from 0 to 2.0% by mass of Si; from 0 to 2.5% by mass of Fe; the balance of Zn; and unavoidable impurities.

3. The method for producing an arc-welded Zn—Al—Mg alloy coated steel plate structural member excellent in liquid metal embrittlement cracking resistance according to claim 1, wherein the hot dip Zn—Al—Mg alloy coated steel plate has a coating weigh of from 20 to 250 g/m² per one surface.
